(19) United States
(12) Patent Application Publication
(10) Pub. No.: US 2005/0242044 A1
(43) Pub. Date: Nov. 3, 2005

(54) System, method, and apparatus for disinfecting wastewater systems

(76) Inventor: Weldon Couch, Florence, TX (US)

Correspondence Address: BRACEWELL & GIULIANI LLP, P.O. Box 61389, HOUSTON, TX, 77208-1389, US

(21) Appl. No.: 11/120,821

(22) Filed: May 3, 2005

Related U.S. Application Data
(60) Provisional application No. 60/567,579, filed on May 3, 2004.

(51) Int. Cl. C02F 1/50

(52) U.S. Cl. 210/744; 210/764; 210/104; 210/205

(57) ABSTRACT

A system for disinfecting treated effluent has a liquid disinfectant reservoir with a fill tube containing a float. The float moves with the level of disinfectant to automatically indicate to the user when to refill the reservoir. A pump tube contains a buoyant pump that moves with the level of liquid that the system is treating. The pump draws additional disinfectant from the reservoir as needed. As the level of treatable fluid rises in the pump tube, the outflow of disinfectant is discharged into a basin to allow the disinfectant to mix with incoming treatable liquids to initiate the disinfection process. The system is employed as part of an underground wastewater treatment system.

### RELATED PATENT APPLICATION

The present application claims the priority of U.S. Provisional Patent Application No. 60/567,579 (Attorney Docket No. 019627-000006), filed on May 3, 2004, entitled System, Method, and Apparatus for Disinfecting Aerobic Wastewater Systems by Liquid Chlorination, and is incorporated herein by reference.

### BACKGROUND OF THE INVENTION

1. Technical Field

The present invention relates in general to disinfecting liquids and, in particular, to an improved system, method, and apparatus for disinfecting aerobically treated effluent with a liquid chlorination device.

2. Description of the Related Art

The treatment of wastewater, whether for purposes of recycling or prior to its discharge into treatment works, rivers, lakes, groundwater suppliers, etc., is an ever-increasing problem. To date, three general classes of methods for removing contaminating organic substances from wastewater, such as sewage, have been developed. These are chemical treatments, biological treatments, and physical treatments.

Biological treatments have been used in a wide variety of applications. Generally, the treatment involves contacting wastewater with a microorganisms that utilize dissolved organic substances as nutrients. During the biological treatment, three main activities occur: reduction of biological oxygen demand (B.O.D.) reduction, nitrification and denitrification of the organic waste. All three processes are affected by bacteria, the former two by aerobic bacteria, and the latter by anaerobic bacteria.

In the various reactors for biological treatment of sewage, mutual disposition of the biological activities in the overall treatment may be different in that the denitrification stage may be performed before, concurrently or after B.O.D. reduction. When denitrification is performed before B.O.D. reduction and nitrification, this may take place either in a separate reactor or in the area of the main reactor where the raw sewage enters. When denitrification is performed after B.O.D. reduction and nitrification, the system typically requires its supplementation with an additional source of carbon, such as methanol, in order to effect denitrification. When denitrification, B.O.D. reduction, and nitrification occur concurrently in a so called combined system, this system typically comprises alternating aerobic and anaerobic stages in which incremental reduction in the organic carbon and nitrogen content of the sewage is accomplished in each stage. This enables the system to maintain the organic carbon after the B.O.D. reduction stages at a sufficient level for denitrification without adding an additional source of carbon. Systems of this type are disclosed, for example, in U.S. Pat. Nos. 3,994,802; 3,945,918; 4,279,753; 4,564,457 and 4,374,730.

Typically, the combined systems for biological treatment of sewage hitherto known are designed to include the use of aeration and/or agitation means during the aerobic stage of the treatment for the purpose of reduction of the time required for nitrification. Nearly all prior art sewage purification systems require that sooner or later the system be closed down to allow removal of sludge that has not been fully treated and has accumulated in the processing vessels. Large municipal treatment plants have the equipment and personnel to carry out this work. However, small-scale systems intended for the use of a single house or housing blocks are better served by arrangements that almost completely dispose of organic solids and so do not require such servicing.

Methods and apparatus for treating domestic effluents are disclosed in U.S. Pat. No. 4,172,034 (Carlsson, et al); U.S. Pat. No. 4,812,237 (Cawley); U.S. Pat. No. 5,114,586 (Humphrey) and U.S. Pat. No. 5,342,523 (Kuwashima). Carlsson describes an apparatus, which operates on an easy-flowing slurry, having a dry solids content of between 1-15%, preferably 5-10%. Such a dilute slurry unnecessarily extends processing time to achieve aerobic degradation in a reaction vessel with aeration; however, the Carlsson apparatus has the advantage of being compact.

Humphrey discloses a complex sanitation system provided with many vessels, five of which have multiple air entry orifices. The resulting high air consumption necessitates the installation of a large air blower or compressor, leading to high running costs and a noise suppression problem. Another difficulty encountered in the Humphrey system is finding space in a residential building for all the described system components.

Cawley describes and claims a process for purifying and recycling household wastewaters, comprising the steps of (a) collecting a first wastewater stream from household kitchen sources; (b) anaerobically digesting said first wastewater stream in a first septic tank; (c) collecting a second wastewater stream from household laundry and bathing sources; (d) combining water from steps (b), (c) and (h); (e) anaerobically digesting water from step (d) in a second septic tank; (f) pumping water from step (e) over a biological sand filter under aerobic conditions; (g) pumping biologically filtered water from step (f) through an ultra-filter, thereby separating the biologically filtered water into a retentate stream and a permeate stream; (h) returning said retentate stream to step (d); (i) disinfecting said permeate stream; (j) returning a first portion of said disinfected permeate stream to household laundry and bathing facilities; (k) separating a second portion of said disinfected permeate stream into a low salt portion and a high salt portion; (l) returning said low salt portion to a household kitchen; and (m) disposing of said high salt portion.

Kuwashima proposes a pair of separator tanks, which are used alternately for separating floating or sedimenting material; the organic material is transferred for aerobic decomposition to a third tank. The device lacks means for breaking up large solids into small particles for efficient decomposition. Although each of these prior art designs are workable, a more effective and efficient means of treating and disinfecting wastewater would be desirable.

### SUMMARY OF THE INVENTION

One embodiment of a system, method, and apparatus for disinfecting treated effluent has a reservoir for liquid disinfectant with a fill tube containing a float. The float moves with the level of disinfectant in the reservoir to automatically indicate to the user when to refill the reservoir. A draw tube draws liquid out of the reservoir and through a series of valves. A pump tube contains a buoyant pump that moves with the level of liquid that the system is treating. The pump draws additional disinfectant from the reservoir as needed. As the level of treatable fluid rises in the pump tube, the outflow of disinfectant is discharged into a basin to allow the disinfectant to mix with incoming treatable liquids to initiate the disinfection process.

The present invention may be employed as part of an underground disinfection system in, for example, an underground wastewater treatment system. The system is mounted inside a disinfection tank that receives treated effluent from the wastewater treatment system. When discharge enters the system, it goes through the basin to mix with an initial amount of disinfectant. The mixture spills out of the basin and begins to fill the tank. As the level of the mixture rises in the tank, the pump rises with it and forces additional disinfectant into the basin and the disinfected mixture flows out of the tank. As the level of the mixture lowers in the tank, the pump draws additional disinfectant from the reservoir to maintain a balance between the disinfectant and the mixture.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the invention, as well as others which will become apparent are attained and can be understood in more detail, more particular description of the invention briefly summarized above may be had by reference to the embodiment thereof which is illustrated in the appended drawings, which drawings form a part of this specification. It is to be noted, however, that the drawings illustrate only an embodiment of the invention and therefore are not to be considered limiting of its scope as the invention may admit to other equally effective embodiments.

FIG. 1 is a sectional side view of one embodiment of a disinfection device constricted in accordance with the present invention.

FIG. 2 is a sectional side view of the device of FIG. 1 shown mounted in a disinfection tank and in operation with an aerobic wastewater treatment system.

### DETAILED DESCRIPTION OF THE INVENTION

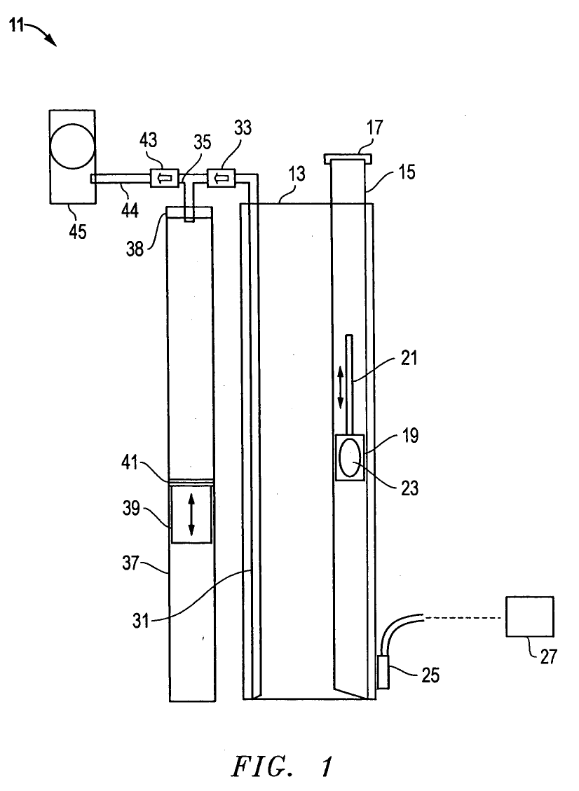

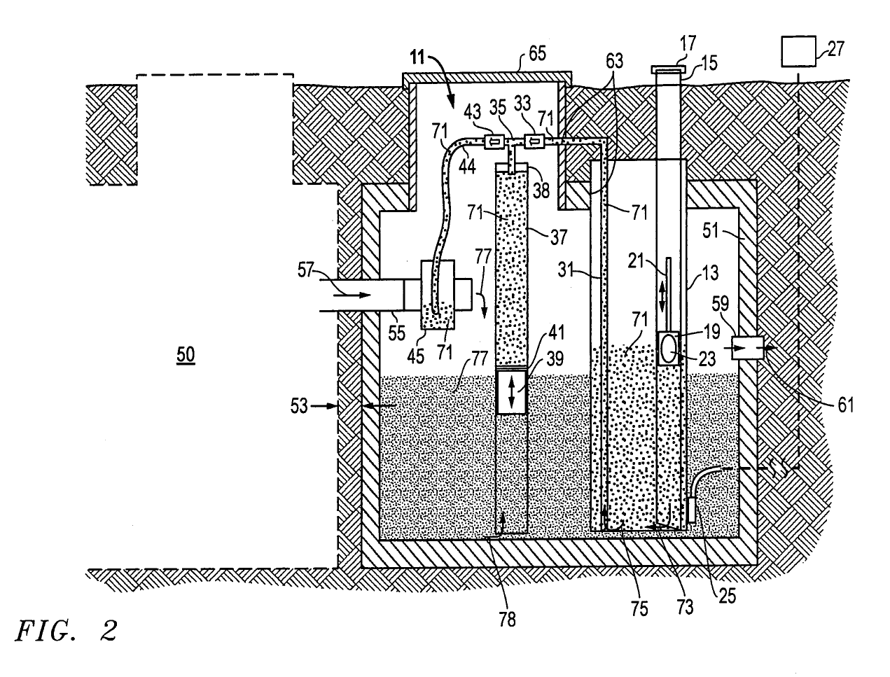

Referring to FIGS. 1 and 2, one embodiment of a system and apparatus 11 for disinfecting liquids is shown. Apparatus 11 is particularly well-suited for disinfecting aerobically treated effluent as a liquid chlorination device, as will be described below. Aerobic treatment systems that utilize surface discharge to expel their treated effluent are typically required to have a secondary treatment before discharging their contents.

In the embodiment shown, apparatus 11 has a reservoir 13 for storing an adequate supply of liquid disinfectant, such as commonly available household chlorine bleach (sodium hypochlorite). The reservoir 13 may comprise a closed upright cylinder or box-like container, and is provided with a hollow fill tube 15 for replenishing its liquid contents. Fill tube 15 has a smaller diameter than reservoir 13 and extends from the bottom of reservoir 13 up through an aperture in the top of reservoir 13. The lower end of fill tube 15 is configured to permit disinfectant to flow between fill tube 15 and reservoir 13. Fill tube 15 is longer (vertically) than reservoir 13 and extends up above the top of reservoir 13 as shown. A removable cap 17 is provided at the top of fill tube 15 for controlling access to fill tube 15 and reservoir 13.

Fill tube 15 contains a float 19 that is buoyant in liquid, such as the disinfectant. The float 19 rises and falls inside fill tube 15 with the level of disinfectant in reservoir 13. The float 19 is designed to serve two purposes. First, the float 19 supports a lightweight mast 21 that is mounted to the upper end of the float 19. The mast 21 is an elongated rod that protrudes upward from the upper end of float 19. Mast 21 is long enough to extend above reservoir 13 when reservoir 13 is full. When the top of the mast 21 is at or near the top of reservoir 13, it is visible in the fill tube 15 when the cap 17 is removed. The mast 21 visually indicates to the person filling the reservoir 13 through fill tube 15 that reservoir 13 is full and can thereby avert overfilling of the reservoir 13.

The second purpose of the float 19 is to facilitate a “low level” indicator to the user of the apparatus 11. In one embodiment, float 19 carries a magnet 23 that works in conjunction with a magnetic switch 25 located at or near the bottom of reservoir 13. As the level of disinfectant in reservoir 13 is depleted, the magnet 23 on float 19 passes in close proximity to the magnetic switch 25. The magnetic switch 25 is thereby triggered by magnet 23 to send a signal to some form of an indicator 27, such as an audio-visual alarm, to indicate to the user that the reservoir 13 is almost empty and needs to be refilled.

The apparatus 11 also employs a draw tube 31 for drawing liquid out of reservoir 13. In the embodiment shown, draw tube 31 is smaller in diameter than fill tube 15 and, like fill tube 15, extends from the bottom of reservoir 13 up through an aperture in the top of reservoir 13. The lower end of draw tube 31 is configured to permit disinfectant to flow from reservoir 13 into draw tube 31. Draw tube 31 is longer (vertically) than reservoir 13 and extends up above the top of reservoir 13 as shown. A check valve 33 is provided in draw tube 31 (e.g., near its upper end) for limiting the direction of flow through draw tube 31. Check valve 33 only permits disinfectant to flow out of reservoir 13.

In one embodiment, a T-fixture 35 is attached to the exit port of check valve 33 to permit the disinfectant flowing out of draw tube 31 to drain into a pump tube 37. T-fixture 35 is sealed to pump tube 37 with, for example, a sealing lid 38. The pump tube 37 contains a buoyant pump 39. Pump 39 is really a piston-like float that has a seal 41, such as a disk with an O-ring seal. Seal 41 seals pump 39 against the inner surface of pump tube 37. As will be described in greater detail below, pump 39 is designed to rise and fall with the level of liquid that apparatus 11 is treating.

As pump 39 descends in pump tube 37, a vacuum is created above seal 41 to draw additional disinfectant through T-fixture 35, check valve 33, and draw tube 31 from reservoir 13. Thus, the volume of pump tube 37 located above seal 41 is substantially filled with the disinfectant liquid from reservoir 13 (unless reservoir 13 is empty). Conversely, the volume of pump tube 37 located below seal 41 is substantially filled with the fluid being treated by apparatus 11 (unless there is no more treatable fluid).

As the level of treatable fluid rises in pump tube 37, pump 39 rises with it. The upward motion of pump 39 forces the disinfectant above it out through T-fixture 35 and another check valve 43 located opposite the first check valve 33. The combination of check valves 33, 43 on T-fixture 35 permits disinfectant to only flow out of pump tube 37 as pump 39 rises. The outflow of disinfectant from check valve 43 is discharged through a hose 44 into a contact basin 45 (e.g., a chambered fitting) that allows the disinfectant to be dispersed in and mix with incoming treatable liquids to initiate the disinfection process.

In operation, one embodiment of the present invention may be employed as part of an underground disinfection system in, for example, an underground aerobic wastewater treatment system 50 (FIG. 2). One example of an aerobic system 50 is described in International Application No. PCT/US03/12522, filed Apr. 23, 2003, which is based on U.S. patent application Ser. No. 60/375,477, filed Apr. 25, 2002, and is incorporated herein by reference.

In the version illustrated (FIG. 2), the apparatus 11 is mounted inside a disinfection tank 51. In one embodiment, the tank 51 is separate from the tank utilized by system 50, and is typically spaced apart therefrom by about four inches of earth 53 as shown. Tank 51 may be formed from concrete and is provided with inlet 55 for receiving treated effluent 57 from aerobic system 50, and an outlet 59 for discharging disinfected liquids 61 for surface discharge, as described above. The outlet 59 is typically located below the inlet 55. Tank 51 also has apertures 63 for accommodating various subcomponents of apparatus 11 that extend outside of tank 51, and an access port 65 for accessing the components of apparatus 11 that are located inside tank 51.

To begin the disinfection process, liquid disinfectant 71 (e.g., household chlorine bleach or sodium hypochlorite) is added to reservoir 13 through fill tube 15. As indicated by arrow 73, the disinfectant flows out of fill tube 15 into reservoir 13. With pump 39 starting at or near the upper end of pump tube 37 and then descending, disinfectant 71 is drawn from reservoir 13 into draw tube 31 (see arrow 75), through check valve 33 and into pump tube 37 above seal 41.

When discharge 57 from aerobic system 50 enters tank 51 through inlet 55, it goes through contact basin 45 where it is allowed to mix with an initial amount of disinfectant 71. The mixture 77 spills out of contact basin 45 into the open volume of the tank 51 and begins filling tank 51. As the level of the mixture 77 rises in tank 51, the buoyant pump 39 rises with it (see arrow 78) and thereby forces additional disinfectant 71 out of pump tube 37, through check valve 43 and into the contact basin 45. The disinfected mixture 61 flows out of the tank 51 through outlet 59.

As the level of mixture 77 is lowered in tank 51 (e.g., releases through outlet 59 as disinfected mixture 61), the pump 39 descends in pump tube 37 with it. In its downward motion, pump 39 draws additional disinfectant 71 from reservoir 13 into pump tube 37, and thereby maintains a self-correcting and properly adjusted balance between the disinfectant 71 and the mixture 77. Eventually, the level of disinfectant 71 in reservoir 13 will diminish over time, causing float 19 to lower within fill tube 15. As the disinfectant 71 and, thus, float 19 reach the lower end of reservoir 13, the magnet 23 on float 19 comes into proximity with the magnetic switch 25, thereby triggering the alarm 27 to notify the user of apparatus 11 that it is in need of additional disinfectant. As described above, reservoir 13 is refilled by removing cap 17 from fill tube 15 and pouring additional disinfectant 71 into fill tube 15 until mast 21 is visible, thereby indicating that reservoir 13 is full. The cap 17 is then replaced on fill tube 15 and the disinfection process continues automatically as before.

The present invention also comprises a method of disinfecting effluent. One embodiment of the method comprises adding a disinfectant to a reservoir; receiving effluent from a wastewater treatment system into a tank; pumping the disinfectant from the reservoir as the effluent increases; mixing the disinfectant with the effluent to form a mixture; and then discharging the mixture from the tank as disinfected effluent.

The method also may comprise floating a float in a fill tube in the reservoir to indicate a fill level of the disinfectant in the reservoir. The method may further comprise signaling a low level of the disinfectant when the float is located adjacent a bottom of the reservoir. In addition, the signaling may comprise moving a magnet on the float adjacent a magnetic switch located adjacent the bottom of the reservoir. The method also may comprise floating a piston in the mixture. A decrease in effluent flow lowers the piston to draw disinfectant into a pump, and an increase in liquids raises the piston to add disinfectant to the mixture. The method may further comprise flowing the disinfectant through a first check valve that limits flow of the disinfectant to a direction out of the reservoir, and flowing the disinfectant through a second check valve that limits flow of the disinfectant to a direction into the tank. Furthermore, the method may comprise mixing in a basin and spilling the mixture from the basin into the tank, as described above.

The present invention has several advantages, including the ability to replace traditional, prior art tablet chlorinators for disinfecting liquids. Chlorine tablets are approximately 50% to 70% more expensive than the off-the-shelf household bleach utilized by the present invention. Moreover, household bleach is available at almost every convenience store or grocery store, but chlorine tablets are typically only available at specialty stores that carry such liquid treatment supplies. The present invention is automated, self-adjusting, and requires only minimal maintenance to replenish its reservoir supply of inexpensive household bleach. Furthermore, the system warns the user when the disinfectant is low so that the system remains operational while reducing the risk of discharging infected liquids.

While the invention has been shown or described in only some of its forms, it should be apparent to those skilled in the art that it is not so limited, but is susceptible to various changes without departing from the scope of the invention.

1. An apparatus for disinfecting liquids, comprising:
a disinfection tank, containing:
a reservoir adapted to store disinfectant;
a pump adapted to pump the disinfectant;
a basin adapted to mix the disinfectant with the liquids;
tubing extending from the reservoir to the pump and from the pump to the basin; and
a valve system located in the tubing between the pump, the basin, and the draw tube.

2. An apparatus according to claim 1, wherein the disinfection tank is a liquid chlorination device adapted to be attached to an underground aerobic wastewater treatment system for disinfecting aerobically treated effluent.

3. An apparatus according to claim 1, wherein the disinfectant is liquid sodium hypochlorite.

4. An apparatus according to claim 1, wherein the reservoir has a fill tube extending from a bottom of the reservoir to a fill position located above the reservoir, the fill tube containing a float that is buoyant in the disinfectant, the float being visible to a user when adjacent the fill position, and the float indicating a low level of disinfectant when located adjacent the bottom.

5. An apparatus according to claim 4, wherein the float has a magnet that triggers a magnetic switch located adjacent the bottom of the reservoir to send a signal to an indicator to indicate to the user that the reservoir is almost empty and needs to be refilled.

6. An apparatus according to claim 1, wherein the valve system comprises a first check valve between the reservoir and the pump for limiting flow of the disinfectant to a direction out of the reservoir, and a second check valve between the pump and the basin for limiting flow of the disinfectant to a direction out of the pump.

7. An apparatus according to claim 1, wherein the pump includes a piston that is buoyant in the liquids, such that a decrease in liquids lowers the piston to draw disinfectant into the pump, and an increase in liquids raises the piston to add disinfectant to the basin.

8. An apparatus according to claim 1, further comprising a warning system for warning a user when a quantity of the disinfectant is low and in need of replenishment.

9. A system for processing liquids, comprising:
a wastewater treatment system for receiving and processing liquids and discharging effluent;
a disinfection tank for receiving and disinfecting the effluent, the disinfection tank containing:
a reservoir for storing a liquid disinfectant;
a pump for pumping the disinfectant;
a basin for mixing the disinfectant with the effluent;
tubing extending from the reservoir to the pump and from the pump to the basin; and
a valve system located in the tubing between the pump, the basin, and the draw tube.

10. A system according to claim 9, wherein the wastewater treatment system and the disinfection tank are underground, and the disinfection tank is connected to but separate from the wastewater treatment system.

11. A system according to claim 9, wherein the disinfectant is sodium hypochlorite.

12. A system according to claim 9, wherein the reservoir has a fill tube extending from a bottom of the reservoir to a fill position located above the reservoir, the fill tube containing a float that is buoyant in the liquid disinfectant, the float being visible to a user when adjacent the fill position, and the float indicating a low level of liquid disinfectant when located adjacent the bottom.

13. A system according to claim 12, wherein the float has a magnet that works in conjunction with a magnetic switch located adjacent the bottom of the reservoir to send a signal to an indicator to indicate to the user that the reservoir is almost empty and needs to be refilled.

14. A system according to claim 9, wherein the valve system comprises a first check valve between the reservoir and the pump for limiting flow of the disinfectant to a direction out of the reservoir, and a second check valve between the pump and the basin for limiting flow of the disinfectant to a direction out of the pump.

15. A system according to claim 9, wherein the pump includes a piston that is buoyant in the liquids, such that a decrease in liquids lowers the piston to draw disinfectant into the pump, and an increase in liquids raises the piston to add disinfectant to the basin.

16. A method of disinfecting effluent, the method comprising:
(a) adding a disinfectant to a reservoir;
(b) receiving effluent from a wastewater treatment system into a tank;
(c) pumping the disinfectant from the reservoir as the effluent increases;
(d) mixing the disinfectant with the effluent to form a mixture; and then
(e) discharging the mixture from the tank as disinfected effluent.

17. A method according to claim 16, wherein step (b) comprises floating a float in a fill tube in the reservoir to indicate a fill level of the disinfectant in the reservoir.

18. A method according to claim 17, further comprising signaling a low level of the disinfectant when the float is located adjacent a bottom of the reservoir.

19. A method according to claim 18, wherein signaling comprises moving a magnet on the float adjacent a magnetic switch located adjacent the bottom of the reservoir.

20. A method according to claim 16, wherein step (c) comprises floating a piston in the mixture.

21. A method according to claim 20, wherein a decrease in effluent flow lowers the piston to draw disinfectant into a pump, and an increase in liquids raises the piston to add disinfectant to the mixture.

22. A method according to claim 16, wherein step (c) comprises flowing the disinfectant through a first check valve that limits flow of the disinfectant to a direction out of the reservoir, and step (d) comprises flowing the disinfectant through a second check valve that limits flow of the disinfectant to a direction into the tank.

23. A method according to claim 16, wherein step (d) comprises mixing in a basin and spilling the mixture from the basin into the tank.
